(19) United States
(12) Patent Application Publication
(10) Pub. No.: US 2025/0126701 A1
(43) Pub. Date: Apr. 17, 2025

(54) APPARATUS FOR GENERATING A PLASMA-ACTIVATED LIQUID, APPARATUS AND METHOD FOR CLEANING AND/OR STERILIZATION

(71) Applicant: TDK Electronics AG, Muenchen (DE)

(72) Inventor: Stefan Nettesheim, Regensburg (DE)

(21) Appl. No.: 18/834,803

(22) PCT Filed: Feb. 2, 2023
(86) PCT No.: PCT/EP2023/052558

§ 371 Date: Jul. 31, 2024

(30) Foreign Application Priority Data
Feb. 4, 2022 (DE) 102022102681.7

(51) Int. Cl. H05H 1/24; B08B 3/10

(52) U.S. Cl. CPC H05H 1/247; H05H 1/2441; B08B 3/10

(57) ABSTRACT

In an embodiment a device includes a first areal electrode and a second areal electrode, the first areal electrode and the second areal electrode being separated from one another by a discharge space, a voltage source configured to apply a voltage between the first areal electrode and the second areal electrode so that an electrical discharge is ignited in the discharge space between the first areal electrode and the second areal electrode, and a liquid supply configured to supply a liquid to the discharge space in such a way that the liquid forms a liquid film in the discharge space, the liquid film being exposed to the electrical discharge when the electrical discharge is ignited in the discharge space.

### CROSS-REFERENCE TO RELATED APPLICATIONS

This patent application is a national phase filing under section 371 of PCT/EP2023/052558, filed Feb. 2, 2023, which claims the priority of German patent application 102022102681.7, filed Feb. 4, 2022, each of which is incorporated herein by reference in its entirety.

### TECHNICAL FIELD

The present invention relates to a device for generating a plasma-activated liquid, a device comprising such a device and methods for cleaning and/or sterilization.

### BACKGROUND

Transferring the chemical reactivity and energy of a gaseous plasma to water or another liquid is a technical approach that can produce a liquid with remarkable transient broad-spectrum biological activity. When water is used as a liquid, this process can produce so-called plasma-activated water (PAW). The properties of PAW make it an environment-friendly solution for a wide range of biotechnological applications, for example in water treatment, surface cleaning and biomedicine. The properties of PAW can also be used to the advantage in various household appliances.

However, the systems known in the state of the art for generating plasma-activated liquids are often highly complex and also do not allow the mixing ratios and dosing of a process liquid and a process gas to be set easily and reliably. As a result, these systems are often unstable in operation. For example, US 2004/0076543 A1 shows a system in which plasma-treated water is used.

### SUMMARY

An embodiment relates to a device for generating a plasma-activated liquid, which has a first areal electrode and a second areal electrode, the first areal electrode and the second areal electrode being separated from one another by a discharge space. The device further comprises a voltage source designed to apply a voltage between the first areal electrode and the second areal electrode, so that an electrical discharge is ignited in the discharge space between the first areal electrode and the second areal electrode. The device has a liquid supply which is designed to supply a liquid to the discharge space such that the liquid forms a liquid film in the discharge space which is exposed to the electrical discharge when the electrical discharge is ignited in the discharge space.

The liquid film can be formed on one of the areal electrodes or on a body arranged in the discharge space. The term liquid film is used here to describe a thin, continuous layer of liquid that wets the surface. A liquid film can differ in its flow properties from a voluminous liquid. A liquid can be described as a liquid film if the thickness of the liquid is less than 1 mm.

During the electrical discharge in the discharge space, species are activated in a gas in the discharge space, for example ozone, NOx and/or peroxides. These activated species can be released into the liquid film, thereby plasma-activating the liquid in the liquid film.

A liquid film is particularly suitable for use in a device for generating a plasma-activated liquid, as the liquid film has a very large surface area compared to a voluminous liquid, which is exposed to the electrical discharge in the discharge space. During an electrical discharge in the discharge space, plasma chemistry induced by the discharge and an energy transfer to the liquid film take place on a large surface area of the liquid film.

At an interface between the liquid film and a gas, an electrical discharge in the discharge space can lead to an exchange of activated species, which are generated in the gas by the electrical discharge. As the liquid film has a large surface area, the exchange of activated species can take place at a high exchange rate. A high exchange rate between the activated species is synonymous with a high efficiency of the device. The use of the liquid film makes it possible to produce a plasma-activated liquid with a high concentration of activated species in a short time. Due to the low thickness of the liquid film, a diffusion-limited exchange rate within the liquid is high and a new equilibrium of active species can be quickly established in the liquid.

The use of a liquid film in a device for generating a plasma-activated liquid, in which the liquid of the liquid film is plasma-activated, also makes it possible to design a simple device with a less complex structure. The liquid can be dosed in a simple manner by adjusting the liquid supply and, if necessary, a liquid discharge. Similarly, the gas used can be dosed by adjusting the flow rate of a gas supply and of a gas discharge. This allows the mixing ratio of liquid and gas in the discharge space to be controlled in a targeted manner. The output stoichiometry in the plasma-activated gas and in the plasma-activated liquid can be easily controlled by a simple and robust dosing system. By selecting a temperature of the overall process in the discharge space, the vapor pressure of the liquid in the gas phase can be adjusted and, thus, the composition of the species formed under energy supply can be varied in the discharge space. The easily adjustable parameters of temperature, flow rate of the liquid and flow rate of the gas can thus make it possible to control the plasma activation of the liquid and to control the type of activated species generated.

An electrode can be described as “areal”, if it is designed to initiate the electrical discharge on its surface. An areal electrode can have an essentially two-dimensional surface to which a voltage can be applied. The areal electrode can be planar and can therefore be arranged essentially in one plane. However, the areal electrode can also have a surface that is not planar but forms a surface of a three-dimensional body, e.g., a surface of a cylinder. An areal electrode has a surface on which the liquid film can be formed.

Preferably, the liquid film has a thickness of 0.2 mm or less, preferably 0.1 mm or less. The thickness of the liquid film can be between 50 nm and 0.2 mm, preferably between 100 nm and 0.1 mm.

If the liquid film has a thickness of less than 50 nm, openings can easily form in the film and the liquid film may not cover one of the areal electrodes or another body continuously, which could result in an uneven electrical discharge. An uneven discharge could damage the device or shorten the life of the device. This is preferably avoided by using a liquid film with a thickness of at least 50 nm.

For a liquid film that has a thickness of 0.2 mm or less, the surface area to volume ratio of the liquid film is sufficiently large so that an exchange of active species at the interface of the liquid film and the gas in the discharge space occurs with high efficiency. Due to the small thickness of the liquid film of 0.2 mm or less, a diffusion-limited exchange rate within the liquid can be high and a new equilibrium of active species can be quickly established in the liquid.

If the liquid film has a thickness in the preferred range of 100 nm to 0.1 mm, the formation of openings in the liquid film is excluded even on poorly wettable substrates and the efficiency of the plasma activation is very high.

The first areal electrode can have a dielectric layer that faces the discharge space. Alternatively or additionally, the second areal electrode can have a dielectric layer that faces the discharge space. If at least one of the two areal electrodes has a dielectric layer, the electrical discharge is ignited as a dielectric barrier discharge.

The dielectric layer can cover the areal electrode on which the liquid film is arranged. As a result, direct contact of the liquid film with a conductive contact surface of the areal electrode can be avoided. Alternatively or additionally, the dielectric layer can cover one of the areal electrodes on which no liquid film is arranged. The dielectric layer can optimize the burning behaviour during electrical discharge.

The dielectric layer of the first areal electrode and/or the dielectric layer of the second areal electrode can be porous and/or rough. Porous and rough layers are characterized by a good wettability with a liquid. In particular, the liquid film can be produced on the dielectric layer. The porous or rough property of the layer can ensure that the liquid film remains on the layer in order to be activated with plasma. The roughness or porosity of the layer ensures that the electrode has good wettability and facilitates homogeneous dosing of the liquid and distribution of the liquid to form a continuous liquid film. Due to the good wetting properties of a rough and/or porous electrode, a defined separation of the liquid phase and gas phase can always be ensured.

The porous layer can have small cavities. A layer can be regarded as porous here if the cavity volume of the layer is at least 5% of the total volume of the layer, preferably 10% of the total volume, in particular 20% of the total volume. A layer is considered rough if the surface of the layer is uneven. Accordingly, the surface of the layer may have microscopic depressions and microscopic elevations which increase the surface area of the layer and facilitate the formation of the liquid film.

The liquid supply can be designed to feed the liquid into the discharge space in such a way that the liquid forms the liquid film on a surface of the first areal electrode facing the discharge space. Preferably, this surface of the first areal electrode is formed by the dielectric layer. By forming the liquid film on the electrode, a simple and less complex device can be constructed in which a large surface of the liquid film is directly exposed to the discharge.

The first areal electrode can comprise a transport layer of a porous material. The transport layer can form the surface of the first areal electrode that faces the discharge space. The porous material of the transport layer can be dielectric. The liquid can both move within the transport layer and form the liquid film on the surface of the transport layer. The transport layer has a high porosity so that the liquid can be moved within the transport layer by capillary forces.

Preferably, the liquid supply is designed to supply a liquid to the transport layer so that the liquid is moved through the transport layer and forms the liquid film on the surface of the transport layer. The use of such a liquid supply, which does not apply the liquid directly to the surface of the first electrode but introduces it into the transport layer, enables particularly precise dosing of the liquid. Liquid can be continuously added via the liquid supply so that a liquid film with a constant thickness remains on the surface of the transport layer.

A porous body can be arranged in the discharge space, which is separated from the first areal electrode and from the second areal electrode by a gap. The liquid supply can be designed to produce the liquid film on a surface of the porous body. Accordingly, no porous film is produced on the electrodes themselves. The liquid film in the gap between the first electrode and the body and a liquid film in the gap between the second electrode and the body can each be plasma-activated. By using the additional porous body, a larger amount of plasma-activated liquid can thus be generated in a single discharge space in this embodiment.

In one embodiment, a porous body may be arranged in the discharge space, which is separated from the first planar electrode and from the second planar electrode by a gap, respectively, wherein the liquid supply is configured to generate the liquid film on a surface of the porous body facing the first electrode and to generate another liquid film on a surface of the porous body facing the second electrode, wherein no liquid film is generated on the first electrode and the second electrode. The porous body may be disposed in a gap between the first electrode and the second electrode.

The device can have a reaction chamber in which the discharge space is arranged. The reaction chamber can have a liquid withdrawal which is designed for dispensing the plasma-activated liquid. The liquid withdrawal can be a valve, for example. The liquid withdrawal can make it possible to remove plasma-activated liquid from the reaction chamber in a controlled manner.

The device may have a liquid reservoir containing the liquid. The liquid supply may be designed to remove the liquid from the liquid reservoir and supply it to the discharge space, the device having a liquid return channel designed to return the liquid from the reaction chamber to the liquid reservoir. The liquid can thus be used in a circuit and activated several times. In addition, plasma-activated liquid can be accumulated in the liquid reservoir. With plasma-activated liquids, the place of production and the place of use can be different. They do not have to be used immediately after production, instead the activated liquid can be stored and used at a later time. Plasma-activated liquids retain their antibacterial effect over a period of several months.

The device can have a gas reservoir, wherein a gas supply is designed to remove a gas from the gas reservoir and supply it to the reaction chamber. The device can be designed to activate the gas in the discharge space during the electrical discharge. The gas can be circulated between the gas reservoir and the reaction chamber and activated several times. Activated gas can be accumulated in the gas reservoir in this way.

The reaction chamber can have a gas outlet that is designed to release the activated gas. The activated gas can be used for cleaning or sterilization, for example.

The device can have a recirculation channel which is designed to return the activated gas from the reaction chamber to the gas reservoir.

The liquid reservoir and the gas reservoir can be connected to each other and an outlet of the recirculation channel can be arranged in the liquid reservoir so that activated gas released at the outlet of the recirculation channel flows through the liquid in the liquid reservoir. For example, the activated gas can be released in the form of bubbles. When flowing through the liquid in the liquid reservoir, the activated gas can release at least some of its active species into the liquid, which is thus enriched with the active species.

The first areal electrode and the second areal electrode can be planar or cylindrically symmetrical. If the first or second areal electrode is cylindrically symmetrical, the respective electrode forms the surface of a cylinder. This can be an inner or outer surface of a hollow cylinder.

The liquid can be moved in the device using only free convection. For example, the device can dispense with active pumping elements and move the liquid using only capillary forces and gravity. This allows the device to work in an energy-efficient manner.

If the liquid film is produced on the first areal electrode or on the second areal electrode, the liquid film can cool the respective electrode. Overheating of the discharge space can thus be avoided. In addition, the liquid could be cooled by means of a cooling mechanism before being fed into the discharge space.

A further embodiment relates to an apparatus comprising the device described above for generating a plasma-activated liquid. The apparatus may be a household appliance, for example a floor care appliance, a cleaning robot, a coffee machine, a dishwasher or a dryer. Alternatively, it can also be other apparatus, for example a water treatment appliance or a medical device used in biomedicine.

Further embodiment relate to a method for cleaning and/or sterilization. In this method, a plasma-activated liquid and/or a plasma-activated gas can be generated with the device described above, wherein the liquid and/or the gas are used for cleaning and/or sterilization.

### BRIEF DESCRIPTION OF THE DRAWINGS

In the following, preferred embodiment examples of the present invention are explained with reference to the figures.

FIG. 1 shows a first embodiment example of a device for generating a plasma-activated liquid;

FIG. 2 shows a second embodiment example of the device;

FIG. 3 shows a third embodiment example of the device;

FIG. 4 shows a fourth embodiment example of the device; and

FIG. 5 shows a fifth embodiment example of the device.

### DETAILED DESCRIPTION OF ILLUSTRATIVE EMBODIMENTS

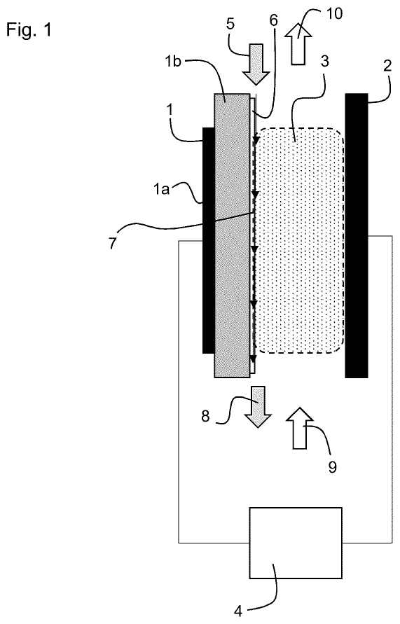

FIG. 1 shows a first embodiment example of a device for generating a plasma-activated liquid. The device has a first areal electrode 1 and a second areal electrode 2. The two areal electrodes are separated from each other by a discharge space 3.

Furthermore, the device has a voltage source 4, which is connected to the first areal electrode 1 and to the second areal electrode 2. The voltage source 4 is designed to apply a voltage between the two areal electrodes 1, 2. The voltage can be an alternating voltage or a pulsed voltage. If a voltage is applied by the voltage source 4 between the two areal electrodes 1, 2, an electric field is created in the discharge space 3 between the two areal electrodes 1, 2, the field strength of which is sufficient to ignite an electric discharge.

The device has a liquid supply 5 that supplies a liquid to the discharge space 3. The liquid can be water or another process liquid, for example. In the embodiment example shown in FIG. 1, the liquid is applied from the liquid supply 5 to a first end of a surface 6 of the first areal electrode 1. The liquid flows along the surface 6 of the first areal electrode 1 and forms a liquid film 7 on the surface 6 of the first areal electrode 1.

At a second end of the surface 6 of the first areal electrode 1, which is opposite the first end, the device has a liquid withdrawal 8. The liquid can be removed from the first areal electrode 1 at the liquid withdrawal 8. Between the liquid supply 5 and the liquid withdrawal 8, the liquid flows as a liquid film 7 through the discharge space 3. In the discharge space 3, the liquid is exposed to the electrical discharge and thereby plasma-activated.

The first areal electrode 1 has a conductive contact surface 1a and a dielectric layer 1b. The conductive contact surface 1a can be a metal surface. The conductive contact surface 1a is connected to the voltage source 4, wherein an electrical potential can be applied to the conductive contact surface 1a by the voltage source 4.

The dielectric layer 1b covers the conductive contact surface 1a in such a way that the dielectric layer forms the surface 6 of the first areal electrode 1, which faces the discharge space 3. The liquid film 7 forms on the surface 6 of the dielectric layer. During the electrical discharge, the dielectric layer 1b acts as a barrier, so that the electrical discharge is ignited as a dielectric barrier discharge (DBD).

The dielectric layer 1b is preferably rough and/or porous. A rough and/or porous layer is characterized by a good wettability with the liquid. The rough and/or porous design of the dielectric layer 1b ensures that the liquid film 7 can be formed on the dielectric layer and that the dielectric layer remains wetted with the liquid.

The second areal electrode 2 has a conductive contact surface 2a, which is connected to the voltage source 4. The conductive contact surface 2a of the second areal electrode 2 is not covered by a dielectric layer.

The device also has a gas supply 9 and a gas outlet 10. A gas is introduced into the discharge space 3 from the gas supply 9 and withdrawn from the discharge space 3 by the gas outlet 10. A flow direction of the gas from the gas supply to the gas outlet can be opposite to a flow direction of the liquid from the liquid supply 5 to the liquid extraction 8. The gas can be air or another process gas.

The electrical discharge in the discharge space 3 generates chemical species, e.g. ozone, NOx or peroxides, in the gas in the discharge space 3. The interface of the liquid film 7 is in contact with the gas and absorbs species generated from a gas phase of the gas at the interface. The gas is enriched with the generated species by the electrical discharge and can also absorb vapor, for example water vapor, through the exchange with the liquid film.

The liquid of the liquid film 7 enriched with the chemical species thus becomes a plasma-activated liquid. The gas is also enriched with the chemical species and water vapor and is therefore also plasma-activated. The device thus produces a plasma-activated liquid and a plasma-activated gas.

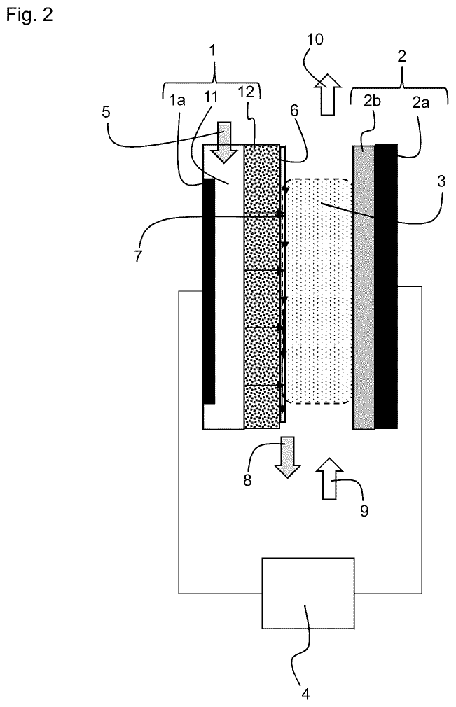

FIG. 2 shows a second embodiment example of the device for generating the plasma-activated liquid.

According to the second embodiment example, the first areal electrode 1 has a conductive contact surface 1a, a liquid distributor 11 and a porous transport layer 12, which are stacked on top of each other, wherein the porous transport layer 12 forms the surface 6 of the first areal electrode 1 facing the discharge space 3.

The liquid distributor 11 is connected to the liquid supply 5. The liquid supply 5 feeds the liquid to the liquid distributor 11, via which the liquid is fed to the porous transport layer 12. The liquid distributor 11 can be a volume that is filled with liquid by the liquid supply 5. In its simplest embodiment, the liquid distributor 11 can thus be a vessel. In alternative embodiments, the liquid distributor 11 can be a structured volume that has, for example, a meandering or channel-shaped distributor structure.

The porous transport structure 12 draws the liquid out of the liquid distributor 11 by capillary forces. In the porous transport layer 12, the liquid is moved through the transport layer 12 by capillary forces and spread out to form a liquid film 7 on the surface of the porous transport layer 12. The liquid can be continuously replenished via the liquid distributor 11. The liquid film 7 on the surface 6 of the porous transport structure is exposed to the electrical discharge in the discharge space 2. As a result, the liquid film 7 is plasma-activated, as described in connection with the first embodiment example.

In the embodiment example shown in FIG. 2, the second areal electrode 2 is coated with a dielectric layer 2b. The dielectric layer 2b forms a dielectric barrier to the discharge space 3, so that the electrical discharge is ignited as a dielectric barrier discharge. The liquid of the liquid film 7 formed on the surface 6 of the first areal electrode 1 is activated by the dielectric barrier discharge and can be removed as activated liquid at the liquid withdrawal. In particular, the liquid can move from the surface of the first areal electrode 1 to the liquid withdrawal 8 by gravitational force.

The liquid in the liquid distributor 11 is located between the conductive contact surface 1a of the first areal electrode 1 and the second areal electrode. This means that the liquid in the liquid distributor 11 is in a current path when an electrical discharge occurs. To ensure that the electrical discharge is not negatively influenced by the liquid, it is necessary for the liquid to have a certain conductivity.

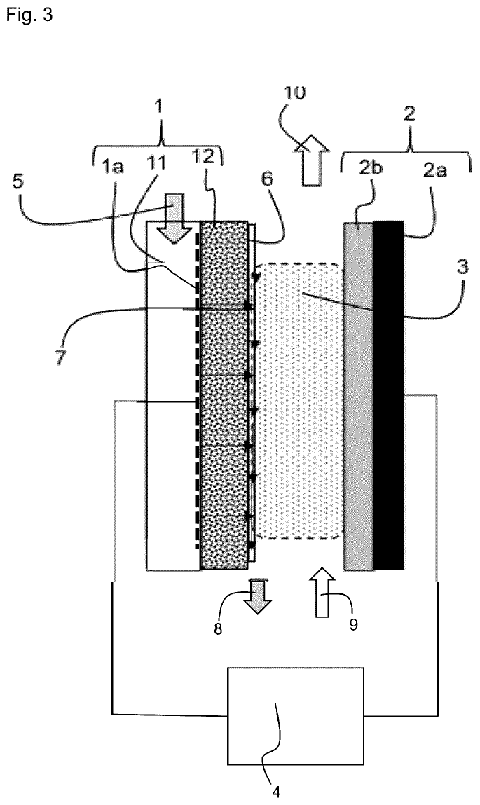

FIG. 3 shows a third embodiment example of the device. The third embodiment example is a modification of the second embodiment example, in which the position of the first areal electrode has been changed.

In the third embodiment example, the first areal electrode is arranged between the liquid distributor 11 and the transport layer 12. The first areal electrode has openings through which the liquid passes from the liquid distributor 11 to the porous transport layer 12.

In the third embodiment example, the liquid in the liquid distributor 11 is not arranged in the current path during an electrical discharge. Accordingly, in the third embodiment example, there is no restriction with regard to the liquid that can be used.

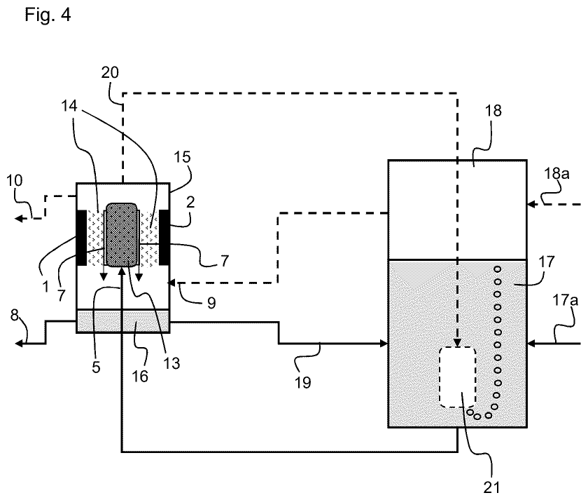

FIG. 4 shows a device for generating a plasma-activated liquid according to a fourth embodiment example.

The fourth embodiment example differs from the previous embodiment examples in that the liquid and the gas are each circulated in a circuit. A further difference between the fourth embodiment example and the first to third embodiment examples is that the liquid film 7 is not formed on a surface of one of the two areal electrodes 1, 2, but on a porous body 13 which is arranged in the discharge space 3 and which is separated from the first areal electrode 1 and from the second areal electrode 2 by a gap 14.

Both differences are to be considered separately and can also be provided individually in alternative embodiments of the embodiment examples in FIG. 1, FIG. 2 or FIG. 3. In particular, the liquid film 7 could be formed on the porous body 13 in the discharge space 3 without the gas and/or liquid being circulated. Alternatively, the gas and/or the liquid could be circulated and the liquid film 7 could be formed on a surface of one of the two areal electrodes 1, 2.

The device shown in FIG. 4 comprises a reaction chamber 15. The first and second areal electrodes 1, 2 are arranged in the reaction chamber 15. The discharge space 3 between the two electrodes 1, 2 is also arranged in the reaction chamber 15. The porous body 13 is arranged in the discharge space 3. The liquid supply 5 applies the liquid to the porous body 13. For this purpose, the porous body 13 can be dripped with the liquid, for example. Alternatively, the liquid supply 5 could have a tube whose outlet either rests against the porous body 13 or is enclosed by the porous body 13.

The liquid is moved through the porous body 13 and along the surface of the porous body 13 by capillary forces and forms the liquid film 7 on the surface of the porous body 13. The electrical discharge is now ignited in the gap 14 between the first areal electrode 1 and the porous body 13 and in the gap 14 between the second areal electrode 2 and the porous body 13. The electrical discharge in the discharge space 3 generates chemical species, e.g., ozone, NOx or peroxides, in the gas. Chemical species and water vapor are exchanged at the interface between the liquid film and the gas. The liquid film is activated with the chemical species. The gas is also enriched with the chemical species and water vapor.

The liquid film 7 flows along the surface of the porous body 13 and, due to the gravity, drips into a collection container 16 arranged under the porous body 13, in which plasma-activated liquid is collected.

The reaction chamber 15 is gas- and liquid-tight in order to prevent the uncontrolled escape of plasma-activated gas, in particular ozone. However, the reaction chamber 15 has the inlets and outlets for gas and liquid described below. The reaction chamber 15 has the liquid withdrawal 8, via which plasma-activated liquid can be withdrawn from the collection container 16. The extracted liquid can be used for a desired purpose, for example for cleaning, sterilization, activation, etc. The reaction chamber 15 has the gas outlet 10, via which the activated gas can be removed from the reaction chamber 15. The activated gas can also be used for cleaning, sterilization, activation or similar purposes.

The device shown in FIG. 4 also has a liquid reservoir 17 and a gas reservoir 18. The gas reservoir 18 and the liquid reservoir 17 can be connected to one another and can, for example, be formed in a single container.

The device has a liquid return channel 19 via which plasma-activated liquid can be removed from the collection container 15 and fed to the liquid reservoir 17. Accordingly, the liquid can be moved in a circuit, wherein the liquid is first removed from the liquid reservoir 17 by the liquid supply 5 and fed to the porous body 13. After plasma activation in the discharge space 3, the liquid enters the collection container 15 and is then either withdrawn and used at the liquid withdrawal 8 or returned to the liquid reservoir 17 via the liquid return channel 19. In this way, plasma-activated liquid can be collected in the liquid reservoir 17.

Gas can be removed from the reaction chamber 15 via a recirculation channel 20 and fed to the gas reservoir 18. An outlet 21 of the recirculation channel 20 can be arranged in the liquid reservoir 17. Accordingly, the gas that is returned from the discharge space 3 to the gas reservoir 18 first flows through the liquid reservoir 17. For example, the outlet 21 of the recirculation channel 20 can have a bubble former that ensures that the recirculated gas rises through the liquid in the form of bubbles. At least some of the active species from the recirculated gas goes into solution and enriches the liquid in the liquid reservoir 17.

The gas is circulated. The gas is initially located in the gas reservoir 18 and is removed from this by the gas supply 9 and fed to the discharge space 3. In the discharge space 3, the gas is activated by the electrical discharge. The gas is then either removed at the gas outlet 10 or returned from the discharge space 3 to the gas reservoir 18 via the recirculation channel 10.

The liquid circuit and the gas circuit can be controlled by means of elements whose operation is controlled by differential pressures, in particular by means of pumps, valves and throttles.

The gas reservoir 18 and the liquid reservoir 17 can each be equipped with a post-dosing mechanism 17a, 18a. New, fresh liquid can be supplied to the liquid reservoir via the post-dosing mechanism 17a. New, fresh gas can be supplied to the gas reservoir 18 via the post-dosing mechanism 18a. In this way, the withdrawal of liquid via the liquid withdrawal 8 and the withdrawal of gas via the gas outlet 10 can be balanced out.

The chemical composition of the circulating liquids and gases can be adjusted using the post-dosing mechanisms 17a, 18a. A quantity ratio between fresh, non-activated gas and activated gas can be set as required. A quantity ratio between fresh, non-activated liquid and activated liquid can also be set.

A pump can also be arranged in the container, which ensures that the liquid circulates in the liquid reservoir 17.

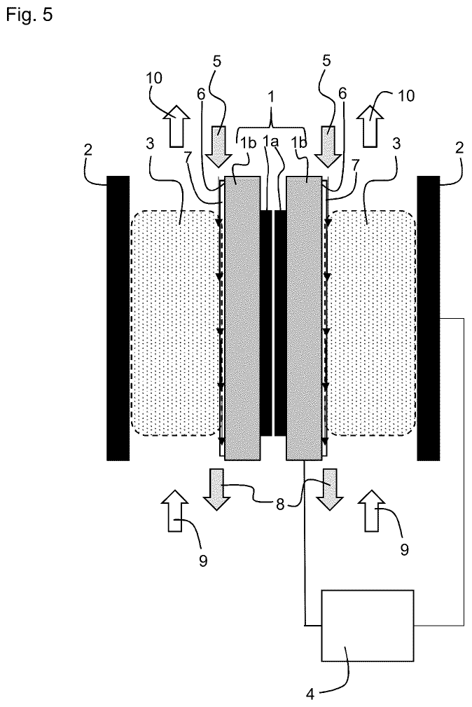

FIG. 5 shows a cross-section of a device according to a fifth embodiment example. In the first to fourth embodiment examples, the areal electrodes 1, 2 are each essentially two-dimensional surfaces that extend in a plane. In the fifth embodiment example, the first areal electrode 1 and the second areal electrode 2 are each curved into a cylindrical shape. The first areal electrode 1 forms an inner cylinder and the second areal electrode forms an outer cylinder, wherein the two cylinders are arranged concentrically to one another. The outer cylinder surrounds the inner cylinder.

The discharge space 3 is arranged in a cavity between the cylinder formed by the first areal electrode 1 and the cylinder formed by the second areal electrode 2. The discharge space 3 is ring-shaped or sleeve-shaped.

The fifth embodiment example is based on the first embodiment example. The liquid film 7 is produced on the surface of the dielectric layer 1b, which faces the discharge space 3, as explained in connection with the first embodiment example. Because the two areal electrodes 1, 2 are each curved into three-dimensional cylinders, the area available for the liquid film is increased and a larger amount of plasma-activated liquid can be generated.

In an alternative embodiment, the second areal electrode 2 can form the inner cylinder and the first areal electrode 1 can form the outer cylinder.

Furthermore, the first areal electrode 1 and the second areal electrode 2 can also be curved into a cylindrical shape in the second, third and fourth embodiment examples. Either the first areal electrode 1 can form the inner cylinder and the second areal electrode 2 can form the outer cylinder. Alternatively, the first areal electrode 1 can form the outer cylinder and the second areal electrode 2 can form the inner cylinder.

In the fourth embodiment example, the porous body 13 is annular in this alternative embodiment. The annular porous body 13 is arranged in the annular discharge space 3 between the first areal electrode 1, which forms a cylinder, and the second areal electrode 2, which also forms a cylinder.

The plasma-activated liquid produced with the device according to one of the embodiment examples shown here can be used for various applications. For example, the liquid can be stored in a container and used as a regenerative cleaning agent. The liquid retains its beneficial properties for cleaning and sterilization for several months.

The liquid can be poured into a spray bottle and sprayed for use. A sponge can be soaked with the liquid and the liquid can be applied via the sponge to a surface to be treated. The liquid can also be used in a dosing dispenser or in a cloth. The liquid can be used in a dry or moist chamber for cleaning, care or sterilization of objects, for example in a dishwasher, for sterilization of a mouth and nose protector or braces.

The device can be integrated into a variety of household appliances in which the plasma-activated liquid can be used for cleaning, sterilization or activation. For example, the device can be used in a floor care appliance, a cleaning robot or a coffee machine for cleaning or descaling. The device could be integrated into a dishwasher, a washing machine or a dryer so that the beneficial properties of the plasma-activated liquid and the plasma-activated gas can be utilized.

1-23. (canceled)

24. A device for generating a plasma-activated liquid, the device comprising:
a first areal electrode and a second areal electrode, the first areal electrode and the second areal electrode being separated from one another by a discharge space;
a voltage source configured to apply a voltage between the first areal electrode and the second areal electrode so that an electrical discharge is ignited in the discharge space between the first areal electrode and the second areal electrode; and
a liquid supply configured to supply a liquid to the discharge space in such a way that the liquid forms a liquid film in the discharge space, the liquid film being exposed to the electrical discharge when the electrical discharge is ignited in the discharge space.

25. The device according to claim 24,
wherein the liquid in the liquid film is plasma-activated by the electrical discharge.

26. The device according to claim 24,
wherein the liquid film has a thickness of between 50 nm and 0.2 mm, inclusive.

27. The device according to claim 24,
wherein the first areal electrode has a first dielectric layer, which faces the discharge space, and/or
wherein the second areal electrode has a second dielectric layer, which faces the discharge space.

28. The device according to claim 27,
wherein the first dielectric layer is porous and/or rough,
and/or
wherein the second dielectric layer is porous and/or rough.

29. The device according to claim 24,
wherein the liquid supply is configured to supply the liquid into the discharge space such that the liquid forms the liquid film on a surface of the first areal electrode facing the discharge space.

30. The device according to claim 24,
wherein the first areal electrode has a transport layer of a porous material, which forms a surface of the first areal electrode facing the discharge space.

31. The device according to claim 30,
wherein the liquid supply is configured to supply the liquid to the transport layer so that the liquid is moved through the transport layer and forms the liquid film on the surface of the first areal electrode.

32. The device according to claim 24, further comprising
a porous body arranged in the discharge space, which is separated from each of the first areal electrode and the second areal electrode by a gap,
wherein the liquid supply is configured to produce the liquid film on a surface of the porous body.

33. The device according to claim 24, further comprising
a porous body arranged in the discharge space, which is separated from each of the first areal electrode and the second areal electrode by a gap,
wherein the liquid supply is configured to produce the liquid film on a surface of the porous body facing the first areal electrode and to produce another liquid film on a surface of the porous body facing the second areal electrode, and
wherein no liquid film is produced on the first areal electrode and the second areal electrode.

34. The device according to claim 24,
further comprising a reaction chamber in which the discharge space is arranged,
wherein the reaction chamber has a liquid withdrawal, which is configured to dispense the plasma-activated liquid.

35. The device according to claim 34,
further comprising:
a liquid reservoir containing the liquid,
wherein the liquid supply is configured to remove the liquid from the liquid reservoir and to supply the liquid to the discharge space; and
a return channel configured to return the liquid from the reaction chamber to the liquid reservoir.

36. The device according to claim 34, further comprising:
a gas reservoir; and
a gas supply configured to take a gas from the gas reservoir and supply the gas to the reaction chamber, and
wherein the device is configured to activate the gas in the discharge space during the electrical discharge.

37. The device according to claim 36,
further comprising a recirculation channel configured to return a plasma-activated gas from the reaction chamber to the gas reservoir.

38. The device according to claim 35,
further comprising:
a gas reservoir;
a gas supply configured to take a gas from the gas reservoir and supply the gas to the reaction chamber; and
a recirculation channel configured to return a plasma-activated gas from the reaction chamber to the gas reservoir,
wherein the liquid reservoir and the gas reservoir are connected to each other and an outlet of the recirculation channel is arranged in the liquid reservoir so that plasma-activated gas discharged at the outlet of the recirculation channel flows through the liquid in the liquid reservoir, and
wherein the device is configured to activate the gas in the discharge space during electrical discharge.

39. The device according to claim 34,
wherein the reaction chamber has a gas outlet configured to release a plasma-activated gas.

40. The device according to claim 24,
wherein the first areal electrode is planar or cylindrically symmetrical,
and/or
wherein the second areal electrode is planar or cylindrically symmetrical.

41. The device according to claim 24,
wherein the device has no actively pumping elements and the liquid in the device is only movable by capillary forces and gravity.

42. The device according to claim 24,
wherein the liquid film is configured to cool the first areal electrode and/or the second areal electrode.

43. An apparatus comprising:
the device according to claim 24,
wherein the apparatus is a floor care appliance, a cleaning robot, a coffee machine, a dishwasher or a dryer, or
wherein the device is a water treatment device or a medical device.

44. A method comprising:
generating, by the device according to claim 24, the plasma-activated liquid; and
using the plasma-activated liquid for cleaning and/or sterilization.

45. A method comprising:
generating, by the device according to claim 24, an activated gas; and
using the activated gas for cleaning and/or sterilization.
